(19) United States
(12) Patent Application Publication
(10) Pub. No.: US 2026/0171085 A1
(43) Pub. Date: Jun. 18, 2026

(54) METHOD AND APPARATUS FOR DOMAIN CLASSIFICATION OF SPEECH RECOGNITION

(71) Applicants: HYUNDAI MOTOR COMPANY, Seoul (KR); KIA CORPORATION, Seoul (KR)

(72) Inventor: Seong Soo Yae, Hwaseong-si (KR)

(73) Assignees: HYUNDAI MOTOR COMPANY, Seoul (KR); KIA CORPORATION, Seoul (KR)

(21) Appl. No.: 19/272,884

(22) Filed: Jul. 17, 2025

(30) Foreign Application Priority Data
Dec. 18, 2024 (KR) 10-2024-0189704

(51) Int. Cl. G10L 15/19; G10L 15/08; G10L 15/18; G10L 15/22

(52) U.S. Cl. CPC G10L 15/19; G10L 15/1815; G10L 15/22; G10L 2015/088; G10L 2015/223

(57) ABSTRACT

A method and an apparatus select a domain intended by a user from a plurality of domains in response to a voice command of the user. A method for determining a domain for processing the voice command from a plurality of domains includes obtaining a plurality of words included in the voice command, receiving a speech signal from a microphone, converting the speech signal into a plurality of words, calculating a score of the voice command for each of the plurality of domains based on domain scores and part-of-speech scores of each of the plurality of words, selecting a domain for processing the voice command based on the score of the voice command for each of the plurality of domains, and updating the domain scores and the part-of-speech scores of each of the plurality of words based on determining whether the selected domain matches an intent of the user.

### CROSS-REFERENCE TO RELATED APPLICATION

This application claims the benefit of and priority to Korean Patent Application No. 10-2024-0189704, filed on Dec. 18, 2024, in the Korean Intellectual Property Office, the entire disclosure of which is incorporated herein in its entirety by reference.

### TECHNICAL FIELD

The present disclosure relates to a method and apparatus for speech recognition domain classification. More specifically, the present disclosure relates to a method and an apparatus for selecting a domain intended by a user from a plurality of domains in response to a voice command of the user.

### BACKGROUND

The content described in this section provides enhancement for understanding of the background of the disclosure. The content described in this section should not be taken as acknowledgement that the content corresponds to prior art already known to those of ordinary skill in the art.

Speech recognition apparatuses and services include technology for recognizing a user's speech and performing a command or providing information. The speech recognition apparatuses and services may be used to enhance driver convenience in automated vehicles.

Automated vehicles may be provided with one or more speech recognition services provided by separate programs implemented by speech recognition hardware apparatuses. For example, a speech recognition service of a navigation device (or program) and a speech recognition service of a generative AI application for information search, and the like may be provided together.

If accurate domain separation is not performed based on a user's voice command, a navigation domain question may be provided based on an output result from a generative AI domain, or a generative AI domain question may be answered based on an output result from a navigation domain, which causes technical problems and inconvenience to the user.

### SUMMARY

An objective of the present disclosure is to provide a method and apparatus for eliminating or reducing domain classification errors by analyzing a user's utterance pattern based on a user's utterance history and learning domain classification rules. In particular, when multiple speech recognition services are provided at the same time, the present disclosure clearly identifies a domain to which a user's voice command belongs.

Technical objectives to be achieved by the present disclosure are not limited to those described above. Other technical objectives not mentioned above may also be clearly understood from the detailed descriptions given below by those of ordinary skill in the art to which the present disclosure belongs.

The disclosed embodiments solve problems which uniquely arise in the field of speech recognition technology by providing a speech recognition apparatus and a method for determining a domain for processing a voice command of a user from a plurality of domains. The method for determining a domain includes receiving a speech signal from a microphone. The speech signal represents the voice command captured by the microphone. The method further includes converting the speech signal into a plurality of words. The plurality of words represents a transcription of the voice command to text. The method further includes calculating a score of the voice command for each of the plurality of domains based on domain scores and part-of-speech scores of each of the plurality of words. The method also includes selecting a domain for processing the voice command based on the score of the voice command for each of the plurality of domains. The method further includes updating the domain scores and the part-of-speech scores of each of the plurality of words based on determining whether the selected domain matches an intent of the user.

Another embodiment of the present disclosure provides an apparatus for determining a domain for processing a voice command of a user from a plurality of domains. The apparatus includes at least one memory configured to store computer-executable instructions. The apparatus further includes at least one processor configured to execute the computer-executable instructions to receive a speech signal from a microphone. The speech signal represents the voice command captured by the microphone. The at least one processor is further configured to execute the computer-executable instructions to convert the speech signal into a plurality of words. The plurality of words represents a transcription of the voice command to text. The at least one processor is also configured to execute the computer-executable instructions to calculate a score of the voice command for each of the plurality of domains based on domain scores and part-of-speech scores of each of the plurality of words. The at least one processor is further configured to execute the computer-executable instructions to select a domain for processing the voice command based on the score of the voice command for each of the plurality of domains. The at least one processor is also configured to execute the computer-executable instructions to update domain scores and the part-of-speech scores of each of the plurality of words based on whether the selected domain matches an intent of the user.

According to an embodiment of the present disclosure, the at least one processor is also configured to execute the computer-executable instructions to select a domain to be used by a user from a plurality of domains in which a user's voice command may be processed.

Even when voice commands for a plurality of domains are similar, the disclosed embodiments provide a technical solution to eliminate or reduce domain classification errors by analyzing a user's utterance pattern based on a user's utterance history and learning domain classification rules.

The disclosed embodiments further provide a technical solution to specialize domain classification rules to suit characteristics of a user by analyzing a user's utterance pattern based on a user's utterance history and learning the domain classification rules.

The technical solutions provided by the present disclosure are not limited to those described above. Other technical effects of the present disclosure not mentioned above may be understood clearly by those of ordinary skill in the art from the descriptions provided below.

### BRIEF DESCRIPTION OF THE DRAWINGS

FIG. 1 is a block diagram schematically illustrating a domain classification system according to an embodiment of the present disclosure.

FIG. 2 is a flowchart illustrating a process in which a learning module learns domain determination rules according to an embodiment of the present disclosure.

FIG. 3 is a flowchart illustrating a process in which the domain classification system selects a domain corresponding to a user's voice command and corrects a domain classification error according to an embodiment of the present disclosure.

FIG. 4 is a block diagram schematically illustrating acomputing device that can be used to implement a method or apparatus according to an embodiment of the present disclosure.

### DETAILED DESCRIPTION

Hereinafter, various embodiments of the present disclosure are described in detail with reference to the accompanying drawings. In the following drawings, the same reference numerals are used throughout to designate the same or equivalent elements, even though the elements are shown in different drawings. Further, in the following description of various embodiments, a detailed description of well-known functions and configurations incorporated therein has been omitted for the purpose of clarity and for brevity.

Additionally, various terms such as first, second, A, B, (a), (b), and the like, are used solely to differentiate one component from the other but not to imply or suggest the type, order, or sequence of the components. Throughout this specification, when a part ‘includes’ or ‘comprises’ a component, it is to be understood that the part may include other components, unless specifically stated otherwise. When a component, device, element, part, unit, module or the like of the present disclosure is described as having a purpose or performing an operation, function, or the like, the component, device, or element should be considered herein as being “configured to” meet that purpose or to perform that operation or function. Each “part”, “unit”, “module”, “component”, “device”, “element”, and the like may separately embody or be included with a processor and a memory, such as a non-transitory computer readable media, as part of the apparatus.

The following detailed description, together with the accompanying drawings, is intended to describe various embodiments of the present disclosure and is not intended to to limit the scope of the present disclosure to the embodiments described herein.

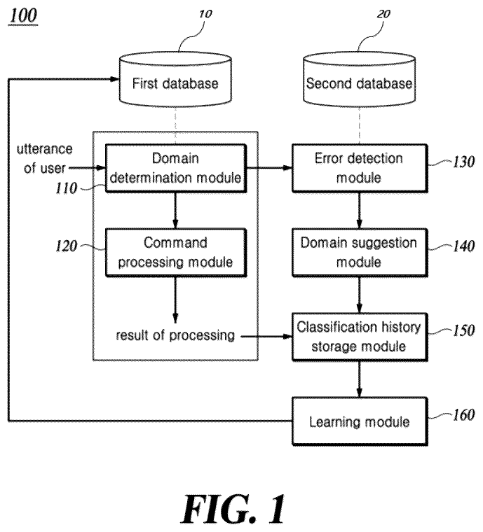

FIG. 1 is a block diagram schematically showing a domain classification system according to an embodiment of the present disclosure.

The domain classification system 100 includes a domain determination module 110, a command processing module 120, an error detection module 130, a domain suggestion module 140, a classification history storage module 150, a learning module 160, a first database 10, and a second database 20. In some embodiments, the domain classification system 100 may include a speech recognition module (not shown). The domain classification system 100 may be implemented in the form of an embedded device, a server, an electronic device in an autonomous driving system, or the like. Not all blocks illustrated in FIG. 1 are essential components. Some blocks included in the domain classification system 100 may be added, changed, or deleted in other embodiments. The components illustrated in FIG. 1 represent functionally distinguished elements, and one or more components may be integrated in an actual physical environment.

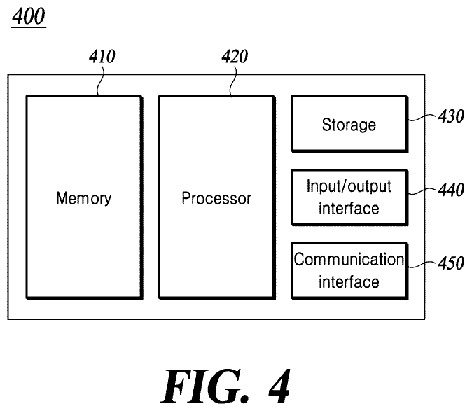

One of ordinary skill in the art should appreciate that one or more modules, e.g., the domain determination module 110, the command processing module 120, the error detection module 130, the domain suggestion module 140, the classification history storage module 150, the learning module 160, and the speech recognition module described herein may be implemented using, among other things, a tangible computer-readable medium or non-transitory memory comprising computer-executable instructions (e.g., executable software code) executed by specifically configured hardware or processors, e.g., one or more processors 420 described in more detail with respect to FIG. 4. It should be appreciated that the disclosed embodiments may be implemented as a different or separate module of the domain classification system 100, or a separate computer system coupled with the domain classification system 100.

The domain determination module 110 receives a user's voice command as input, e.g., an utterance or a voice command of the user. A microphone, e.g., a speech recognition microphone, that may be installed, for example, in a vehicle, may acquire or capture the input utterance, e.g., a user's utterance or voice command, and convert the input utterance to a speech signal. A speech recognition module (not shown) may receive the speech signal and transcribe and convert the speech signal representing the voice command from the microphone into a waveform of the voice command, text data of the voice command, or a plurality of words. In other words, the wave form, text data, or the plurality of words represent a transcription of the voice command into text. The domain determination module 110 may receive the waveform of the voice command or the voice command converted into text data.

The domain determination module 110 may select (determine) a domain for processing a user's voice command from a plurality of domains. For example, the plurality of domains may be a navigation domain and a generative AI domain. The domain determination module 110 may select the navigation domain in response to a user's voice command “Guide route to home” and select the generative AI domain in response to a user's voice command “Find the latest movie”. The process of the domain determination module 110 to select a domain for processing a user's voice command may be referred to as domain classification hereinafter.

The domain determination module 110 may select one of a plurality of domains based on domain classification rules stored in the first database 10.

The first database 10 may store default domain classification rules and/or customized domain classification rules based on a user's utterance pattern. The default domain classification rules refer to default domain classification rules initially designed when a speech recognition system is designed. The customized domain classification rules refer to domain classification rules that reflect a specific user's utterance pattern by analyzing user's utterance patterns.

In an embodiment, the domain determination module 110 initially classifies domains based on the default domain classification rules. However, after training data is accumulated based on the use of users, the domain determination module 110 classifies domains based on domain classification rules customized to an utterance pattern of a corresponding user.

The domain classification rules include domain scores and part-of-speech scores for each of various words.

The domain determination module 110 may calculate a score of a voice command for each of a plurality of domains based on the domain classification rules.

In an embodiment, a score of a voice command for each of the plurality of domains may be calculated as the sum (ΣDᵢ·Pᵢ) of products of domain scores and part-of-speech scores of words included in a user's utterance. Here, Dᵢ is a domain score for a specific domain of each word, and Pᵢ is a part-of-speech score of each word. For example, if a user's voice command is “Guide route to home”, the domain determination module 110 performs part-of-speech tagging (POST) on the voice command string to obtain information on multiple words and parts of speech of the multiple words (“Guide: verb”, “Route: noun”, “To: particle” “Home: noun”), and calculates a score of the voice command for each of the plurality of domains (e.g.,

$${SCORE}_{Navigation} = 1 . {5}_{Guide , Navigation} \cdot {1.}_{Verb} + 2. {0}_{Route , Navigation} \cdot {1.5}_{Noun} + 1 . {5}_{To , Navigation} \cdot {0.5}_{Particle} + 1 . {2}_{Home , Navigation} \cdot {1.5}_{Noun} = 7.05 , {SCORE}_{GenerativeAI} = {1.5}_{Guide , GenerativeAI} \cdot {1.}_{Verb} + {1.2}_{Route , GenerativeAI} \cdot {1.5}_{Noun} + 0 . {8}_{To , GenerativeAI} \cdot {0.5}_{Particle} + 1 . {1}_{Home , GenerativeAI} \cdot {1.5}_{Noun} = 5.35 )$$

The domain determination module 110 may select the domain with the highest score from the plurality of domains as the domain for processing the user's voice command. In the above example, since the score of the navigation domain is 7.05 and the score of the generative AI domain is 5.35, the domain determination module 110 can select the navigation domain as the domain for processing the user's voice command.

The command processing module 120 inputs the user's voice command to the domain selected by the domain determination module 110 and performs a processing result (e.g., performs an operation instructed by the user, displays the result, or provides voice guidance (Text-To-Speech (TTS)). In the above example, since the domain determination module 110 selects the navigation domain, the command processing module 120 inputs the user's voice command to the navigation domain, sets a destination of the vehicle to the user's home according to the processing result of the navigation domain, and then starts driving control based thereon.

The error detection module 130 checks whether domain classification of the domain determination module 110 matches an intent of a user's utterance. If the error detection module 130 determines that the currently selected domain is not the domain intended by the user, the error detection module 130 can determine that an error has occurred in the domain classification. The error detection module 130 may determine a domain classification error based on feedback of the user.

In an embodiment, the error detection module 130 may determine that a domain classification error has occurred based on the determination rules described below.

The error detection module 130 may determine a domain classification error based on an operation of a user to attempt to execute another speech recognition service.

Generally, since different execution screens (or trigger screens) may be displayed in an input/output interface 440 as shown in FIG. 4 and as described below for respective domains, the user can ascertain whether the current domain screen is a desired domain screen by viewing the execution screen. Therefore, when the user performs an operation of executing another speech recognition service in a situation in which speech recognition is triggered and the user can recognize the currently selected domain (e.g., a situation in which the execution screen is displayed), the error detection module 130 may determine that domain classification of the domain determination module 110 is incorrect. The operation of executing another speech recognition service may be, for example, an operation of the user to press a push-to-talk (PTT) button again (repeatedly) and/or an operation of the user to utter a wake-up word again.

The error detection module 130 may determine a domain classification error based on a user's negative utterance for the currently selected domain.

Even when an autonomous driving system processes a user's voice command and transmits the processing result to the user (e.g., displaying the result on the screen, performing voice guidance, or performing vehicle control), a speech recognition microphone is activated to receive the next command. Therefore, if an utterance pattern indicating that domain classification is incorrect (e.g., “What is this?”, “What's wrong with this?”, “This is happening again”, “Idiot”, or the like) is input to the speech recognition microphone when the autonomous driving system executes a voice command, the error detection module 130 may determine that domain classification of the domain determination module 110 is incorrect.

In an additional embodiment, the error detection module 130 may use the second database 20 in which negative word information is stored to determine whether a user's utterance indicates dissatisfaction with domain classification. The second database 20 stores general negative expressions and negative expressions spoken by users. The error detection module 130 may detect negative words in a user's utterance based on the information stored in the second database 20 and rapidly determine that domain classification is incorrect.

The error detection module 130 may additionally determine whether domain classification is valid (i.e., determine that no domain classification error has occurred) based on determination rules described below. The error detection module 130 can increase the accuracy of domain classification by determining that domain classification is valid if all or some of the determination rules below are satisfied.

Based on the user selecting a domain suggested by the domain suggestion module 140 (e.g., responds with “Yes” to the suggested domain), the error detection module 130 may determine that the currently selected domain is invalid and the suggested domain is valid for the current voice command of the user.

Based on the user not retrying the same or similar command while the command processing module 120 is executing the command with the domain suggested by the domain suggestion module 140, or based on the user not manually inputting the same or similar command for a predetermined time, the error detection module 130 may determine that the currently selected domain is valid for the current voice command of the user. Since the user tends to perform a manual operation within a short period of time when the user thinks that the speech recognition system has failed to recognize the voice command, the predetermined time may be, for example, 5 seconds.

Based on the user not inputting another command for a predetermined time (for example, 10 seconds, or 50% of the total output time (or output information amount)) while the command processing module 120 outputs a processing result for the user's voice command (for example, voice guidance), the error detection module 130 may determine that the currently selected domain for the current voice command of the user is valid.

The domain suggestion module 140 induces and processes user feedback on a domain classification error for the current voice command.

The domain suggestion module 140 receives error information on domain classification from the error detection module 130.

The domain suggestion module 140 suggests domain selection to the user based on keywords included in a user's voice command and services provided by domains. The currently selected domain may be excluded from domain candidates suggested to the user.

The domain suggestion module 140 may improve user convenience by suggesting service content rather than directly suggesting a specific domain when suggesting a domain. For example, when a user utters “I want to go to a nearby gas station with low gas prices” for the purpose of using a navigation service, and the domain determination module 110 classifies the user's utterance as a generative AI domain, the domain suggestion module 140 may suggest to the user, “Do you want route guidance to a nearby gas station with low gas prices? [YES] or [NO]”. In addition, for example, when a user utters “Find recent movies” for the purpose of using the generative AI service, and the domain determination module 110 determines that the user's utterance is a navigation domain, the domain suggestion module 140 may suggest to the user, “Shall I tell you about recently released movies? [YES] or [NO]”.

The classification history storage module 150 stores domain classification histories of the domain determination module 110 and/or the domain suggestion module 140. The data stored in the classification history storage module 150 is used as training data of the learning module 160 which are described below.

The data stored in the classification history storage module 150 may be divided into data with valid domain classification and data with invalid domain classification.

First classification data indicates a case in which domain classification of the domain determination module 110 matches a user's intent. The first classification data includes information such as the content of a user's utterance, a domain selected by the domain determination module 110, and the validity of domain determination. For example, the first classification data may be stored in a format such as [dm=navigation domain, cmd= “I want to go to a nearby gas station with low gas prices”, val=True]. Here, dm indicates the type of a domain selected by the domain determination module 110, cmd indicates a voice command uttered by a user, and val indicates whether domain classification is valid or invalid. “val=True” indicates that domain classification is valid, and “val=False” indicates that the domain classification is invalid.

Second classification data indicates a case in which domain classification of the domain determination module 110 does not match a user's intent. The second classification data includes information such as the content of a user's utterance, a domain selected by the domain determination module 110, and the validity of domain determination. For example, the second classification data may be stored in a format such as [dm=generative AI domain, cmd= “I want to go to a nearby gas station with low gas prices”, val=False].

Third classification data indicates a case in which a user selects a new domain by the domain suggestion module 140. The third classification data includes information such as the content of a user's utterance content, a domain selected by the domain determination module 110, and the validity of domain determination. For example, the third classification data may be stored in a format such as [dm=generative AI domain, cmd= “I want to go to a nearby gas station with low gas prices”, val=True].

The learning module 160 is trained to customize the domain classification rules for the user using one or more pieces of classification data stored in the classification history storage module 150, and updates the domain classification rules of the second database 20 to the learned domain classification rules.

A first training data set includes the first classification data, a second training data set includes the second classification data, and a third training data set includes the third classification data.

Based on the domain classification being performed in accordance with the intent of a user's utterance using the first training data set, the learning module 160 is trained to increase the score of the current domain for the corresponding utterance pattern when an utterance identical or similar to the user's utterance is input later.

Based on the domain classification being performed differently from the intent of a user's utterance using the second training data set, the learning module 160 is trained to decrease the score of the current domain for the corresponding utterance pattern when an utterance identical or similar to the user's utterance is input later.

Based on the domain classification being modified according to the intent of a user's utterance using the third training data set, the learning module 160 is trained to increase the score of the modified domain for the corresponding utterance pattern when an utterance identical or similar to the user's utterance is input later.

Therefore, the learning module 160 is trained to increase the score of the selected domain for valid domain classification and trained to decrease the score based on the selected domain being increased, and for invalid domain classification. Thus, when a voice command identical or similar to the user's previous voice command is input later, a domain classification error may be prevented from occurring.

The learning process of the learning module 160 for adjusting the score of a voice command for each of a plurality of domains is described in more detail below.

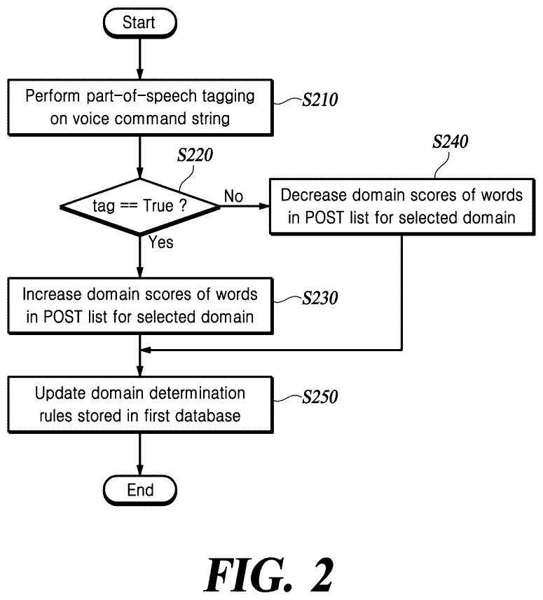

FIG. 2 is a flowchart illustrating the process in which the learning module 160 learns domain determination rules according to an embodiment of the present disclosure.

The learning module 160 performs part-of-speech tagging (POST) on a voice command string (cmd) included in each piece of training data (i.e., classification data) (S210). Part-of-speech tagging is a process of extracting words included in a sentence, identifying the part-of-speech of each word, and assigning a tag to each word. For example, part-of-speech tagging is performed on a user's voice command (cmd= “Guide route to home”) to obtain a POST list in the form of [“Guide: verb”, “Route: noun”, “To: particle”, “Home: noun”].

The learning module 160 checks the domain (dm) selected in response to the user's voice command (cmd) and the validity (val) of domain classification of each piece of training data (S220).

If domain classification is valid (val=True) (S220-YES), the learning module 160 assigns higher domain scores for the selected domain (dm) to the words included in the POST list than before such that the score of the voice command (cmd) for the selected domain (dm) increases (S230). In the above example, when the user's voice command (cmd= “Guide me home”) is classified as a navigation domain (dm=navigation domain), the domain scores of the words included in the POST list for the navigation domain are increased by a predetermined value (e.g., 0.1) (e.g., P_{guide,Navigation}: 1.5→1.6, P_{route,Navigation}=2.0→2.1, P_{to,Navigation}=1.5→1.6, P_{home,Navigation}=1.2→1.3).

If domain classification is invalid (val=False) (S220-NO), the learning module 160 assigns lower domain scores for the selected domain (dm) to the words included in the POST list than before such that the score of the voice command (cmd) for the selected domain (dm) is reduced (S240). In the example above, when the user's voice command (cmd= “Guide route to home”) is classified as a generative AI domain (dm=generative AI domain), the domain scores of the words included in the POST list for the generative AI domain are reduced by a predetermined value (e.g., 0.1) (e.g., P_{guide,generativeAI}: 1.5→1.4, P_{route,generativeAI}=2.0→1.9, P_{to,generativeAI}=1.5→1.4, P_{home,generativeAI}=1.2→1.1).

In an embodiment, the learning module 160 may set the part-of-speech scores of nouns and verbs in utterance content higher than the part-of-speech scores of other parts-of-speech. Furthermore, in an embodiment, the part-of-speech score of a noun may be set to be higher than the part-of-speech score of a verb. For example, the learning module 160 may set the part-of-speech score for a word that is a noun to 1.5, and the part-of-speech score for a word that is a verb to 1.0. This is because nouns generally have a higher correlation with domains than verbs. For example, a user who utters a command containing “my house” is likely to use the navigation domain such as setting a destination, and a user who utters a command containing “movie” is likely to use the generative AI domain such as requesting information about a movie.

When the learning module 160 adjusts the domain scores and part-of-speech scores of words included in a user's utterance, domain classification intended by the user can be achieved when the user utters an utterance similar to a previous utterance in the future.

When learning is completed, the learning module 160 updates the domain determination rules stored in the first database 10 to the modified domain determination rules (S250).

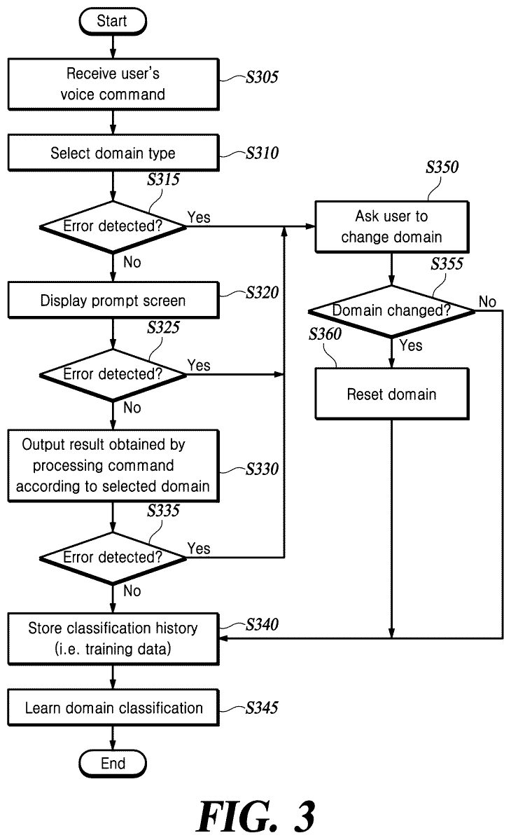

FIG. 3 is a flowchart illustrating a process in which the domain classification system 100 selects a domain corresponding to a user's voice command and updates domain determination rules according to one embodiment of the present disclosure.

The domain classification system 100 receives a user's voice command (S305).

The domain classification system 100 selects a domain, e.g., a domain type, for processing the user's voice command from a plurality of domains (S310). The domain classification system 100 may select a domain corresponding to the user's voice command based on domain determination rules stored in the first database 10.

The domain classification system 100 determines whether the selected domain is a domain that the user intends to use or whether a domain classification error is detected (S315). The domain classification system 100 may determine a domain classification error based on an operation of the user to execute another domain. Based on the domain classification error being detected (S315-YES), the domain classification system 100 asks the user whether to change the domain (S350). Based on a domain classification error not being detected (S315-NO), the domain classification system 100 displays an execution screen (e.g., trigger screen, prompt screen, or the like) of the selected domain to the user (S320).

The domain classification system 100 determines whether the selected domain is a domain that the user intends to use even while the execution screen is displayed (S325). The domain classification system 100 may determine a domain classification error based on an input by the user to execute another domain or a user's negative utterance regarding the currently selected domain. Based on a domain classification error being detected (S325-YES), the domain classification system 100 suggests to the user whether to change the domain (S350). Based on a domain classification error not being detected (S325-NO), the domain classification system 100 outputs the result obtained by processing the user's voice command based on the selected domain (S330), e.g., via the input/output interface 440.

The domain classification system 100 determines whether the selected domain is a domain that the user intends to use even while the result is being output (S335). The domain classification system 100 may determine a domain classification error based on a user's negative utterance regarding the currently selected domain. Based on a domain classification error being detected (S335-YES), the domain classification system 100 suggests to the user whether to change the domain (S350). Based on a domain classification error not being detected (S335-NO), the domain classification system 100 stores classification history data including information on the user's voice command and the corresponding domain (S340).

The domain classification system 100 determines whether the user has selected a new domain in response to domain change suggestion (S355). Based on the user having selected a new domain (S355-YES), the domain classification system 100 changes the current domain to the domain selected by the user (S360) and stores classification history data including information on the user's voice command, the domain before the change, and the domain after the change (S340). Based on the user not selecting a new domain (S355-NO), the domain classification system 100 stores classification history data including information on the user's voice command and the currently selected domain (S340).

The domain classification system 100 learns domain classification rules using the stored domain classification history as training data (S345), as described with reference to FIG. 2.

FIG. 4 is a block diagram schematically illustrating a computing device that can be used to implement the method or apparatus according to an embodiment of the present disclosure.

The computing device 400 may include some or all of a non-transitory memory 410, a processor 420, a storage 430, an input/output interface 440, and a communication interface 450. The computing device 400 may structurally and/or functionally include at least a part of the apparatus according to the present disclosure. The computing device 400 may be a stationary computing device, such as a desktop computer or a server, as well as a mobile computing device, such as a laptop computer, a smartphone, or an automotive electrical system. The computing device 400 may be implemented as any specialized hardware accelerator capable of efficiently processing operations for an artificial intelligence model. For example, the computing device 400 may include a graphic processing unit (GPU), a tensor processing unit (TPU), or a neural processing unit (NPU).

The memory 410 may store a program that causes the processor 420 to perform methods or operations according to various embodiments of the present disclosure. For example, the program may include a plurality of computer-executable instructions executable by the processor 420, and the above-described method or operations may be performed by the processor 420 executing the plurality of computer-executable instructions. The memory 410 may be a single memory or a plurality of memories. In this case, information necessary for performing the methods or operations according to various embodiments of the present disclosure may be stored in a single memory or may be divided and stored in a plurality of memories. When the memory 410 is composed of a plurality of memories, the plurality of memories may be physically separated. The memory 410 may include at least one of a volatile memory and a nonvolatile memory. The volatile memory includes a static random access memory (SRAM) or a dynamic random access memory (DRAM), and the nonvolatile memory includes a flash memory.

The processor 420 may include at least one core capable of executing at least one instruction. The processor 420 may execute computer-executable instructions stored in the memory 410. The processor 420 may be a single processor or multiple processors.

The storage 430 maintains stored data even when power supplied to the computing device 400 is cut off. For example, the storage 430 may include a nonvolatile memory, and may include storage media such as a magnetic tape, an optical disk, and a magnetic disk. A program stored in the storage 430 may be loaded into the memory 410 before being executed by the processor 420. The storage 430 may store a file written in a programming language, and a program generated from the file by a compiler or the like may be loaded into the memory 410. The storage 430 may store data to be processed by the processor 420 and/or data processed by the processor 420.

The input/output interface 440 may provide an interface with input devices such as a keyboard and a mouse and/or output devices such as a display device and a printer. A user may trigger execution of a program by the processor 420 through an input device and/or check a processing result of the processor 420 through an output device.

The communication interface 450 may provide access to an external network. The computing device 400 may communicate with other devices through the communication interface 450.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose or specifically configured processor, coupled to receive and transmit data and computer-executable instructions from and to a storage system, at least one input device, and at least one output device. Computer programs (also known as programs, software, software applications, or code) include computer-executable instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely a description of the technical idea of various embodiments of the present disclosure. In other words, those of ordinary skill in the art to which one embodiment of the present disclosure belongs may appreciate that various modifications and changes may be made without departing from essential features of various embodiments of the present disclosure. In other words, the sequence illustrated in the flowcharts/timing charts may be changed and one or more operations of the operations may be performed in parallel. Thus, flowcharts/timing charts are not limited to the temporal order.

Although various embodiments of the present disclosure have been described for illustrative purposes, those of ordinary skill in the art should appreciate that various modifications, additions, and substitutions are possible, without departing from the idea and scope of the claimed disclosure. Therefore, various embodiments of the present disclosure have been described for the sake of brevity and clarity. The scope of the technical idea of the present embodiments is not limited by the illustrations. Accordingly, one of ordinary skill in the art would understand that the scope of the claimed disclosure is not to be limited by the above explicitly described embodiments but by the claims and equivalents thereof.

What is claimed is:

1. A method for determining a domain for processing a voice command of a user from a plurality of domains, the method comprising:
receiving a speech signal from a microphone, the speech signal representing the voice command captured by the microphone;
converting the speech signal into a plurality of words, wherein the plurality of words represents a transcription of the voice command to text;
calculating a score of the voice command for each of the plurality of domains based on domain scores and part-of-speech scores of each of the plurality of words;
selecting a domain for processing the voice command based on the score of the voice command for each of the plurality of domains; and
updating the domain scores and the part-of-speech scores of each of the plurality of words based on determining whether the selected domain matches an intent of the user.

2. The method of claim 1, wherein determining whether the selected domain matches the intent of the user is based on at least one additional input of the user for changing domain while the voice command is processed based on the selected domain.

3. The method of claim 2, wherein the at least one additional input of the user for changing domain comprises at least one of pushing a Push-To-Talk (PTT) button and uttering a wake-up word.

4. The method of claim 1, wherein determining whether the selected domain matches the intent of the user is based on at least one additional utterance of the user including at least one negative word while the voice command is processed based on the selected domain.

5. The method of claim 1, wherein updating the domain score of each of the plurality of words includes increasing the domain score of each of the plurality of words for the selected domain based on the selected domain matching the intent of the user.

6. The method of claim 1, wherein updating the domain score of each of the plurality of words includes decreasing the domain score of each of the plurality of words for the selected domain based on the selected domain mismatching the intent of the user.

7. The method of claim 1, wherein part-of-speech scores of nouns and verbs are higher than part-of-speech scores of non-noun and non-verb parts of speech.

8. The method of claim 1, wherein part-of-speech scores of nouns are higher than part-of-speech scores of verbs.

9. An apparatus for determining a domain for processing a voice command of a user from a plurality of domains, the apparatus comprising:
at least one memory configured to store computer-executable instructions; and
at least one processor configured to execute the computer-executable instructions to:
receive a speech signal from a microphone, the speech signal representing the voice command captured by the microphone;
convert the speech signal into a plurality of words, wherein the plurality of words represents a transcription of the voice command to text;
calculate a score of the voice command for each of the plurality of domains based on domain scores and part-of-speech scores of each of the plurality of words;
select a domain for processing the voice command based on the score of the voice command for each of the plurality of domains; and
update the domain scores and the part-of-speech scores of each of the plurality of words based on a determination of whether the selected domain matches an intent of the user.

10. The apparatus of claim 9, wherein the at least one processor is further configured to determine whether the selected domain matches the intent of the user based on at least one additional input of the user for changing domain while the voice command is processed based on the selected domain.

11. The apparatus of claim 10, wherein the at least one additional input of the user for changing domain comprises at least one of pushing a Push-To-Talk (PTT) button and uttering a wake-up word.

12. The apparatus of claim 9, wherein the processor is configured to determine whether the selected domain matches the intent of the user based on at least one additional utterance of the user including at least one negative word while the voice command is processed based on the selected domain.

13. The apparatus of claim 9, wherein the processor is configured to update the domain score of each of the plurality of words by increasing the domain score of each of the plurality of words for the selected domain based on the selected domain matching the intent of the user.

14. The apparatus of claim 9, wherein the processor is further configured to update the domain score of each of the plurality of words by decreasing the domain score of each of the plurality of words for the selected domain based on the selected domain mismatching the intent of the user.

15. The apparatus of claim 9, wherein part-of-speech scores of nouns and verbs are higher than part-of-speech scores of non-noun and non-verb parts of speech.

16. The apparatus of claim 9, wherein part-of-speech scores of nouns are higher than part-of-speech scores of verbs.
